(19) United States
(12) Patent Application Publication
(10) Pub. No.: US 2012/0234246 A1
(43) Pub. Date: Sep. 20, 2012

(54) PET BED

(75) Inventor: Josh Randall Spence, Matthews, NC (US)

(73) Assignee: nVision Marketing LLC, Matthews, NC (US)

(21) Appl. No.: 13/047,327

(22) Filed: Mar. 14, 2011

(51) Int. Cl. A01K 29/00

(52) U.S. Cl. 119/28.5

(57) ABSTRACT

The present disclosure includes pet beds including a box-like construction and interior chambers for filler material therein. The interior chambers are defined, at least in part, by interior walls within the pet bed.

### BACKGROUND

Pet beds currently available tend to clump over time due to a separation of the support materials used to fill the beds. A valley is created in the area of the bed where the dog or cat typically rests due to this separation of support materials. As a result, currently available pet beds tend to develop clumps and are uncomfortable for the animal because the support material has moved to one side and/or the other.

### SUMMARY

Embodiments of the present disclosure relate to pet beds. Briefly described, embodiments of the present disclosure include a pet bed comprising a top portion, a bottom portion, a side wall, where the side wall is secured to both the top portion and the bottom portion creating a box-like construction, at least one interior wall, where the at least one interior wall is secured to both the top and bottom portions, at least two interior chambers formed by the top portion, the bottom portion, the side wall, and the at least one interior wall, and a filler material in all of the interior chambers.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B are perspective views of an example of a pet bed in accordance with various embodiments of the present disclosure.

FIGS. 2A-2G are top views of examples of pet beds of FIG. 1 in accordance with various embodiments of the present disclosure.

FIG. 3 is a perspective view of an example of a pet bed of FIG. 1 including an opening for filling in accordance with various embodiments of the present disclosure.

### DETAILED DESCRIPTION

Before the present disclosure is described in greater detail, it is to be understood that this disclosure is not limited to particular embodiments described herein, as such may, of course, vary. It is also to be understood that the terminology used herein is for the purpose of describing particular embodiments only, and is not intended to be limiting, since the scope of the present disclosure will be limited only by the appended claims.

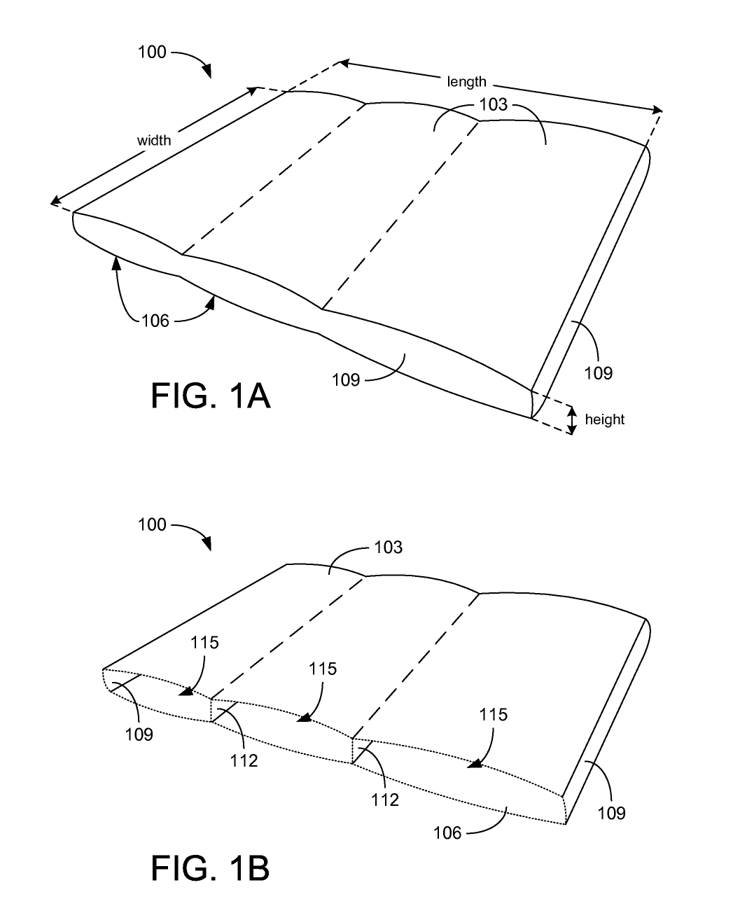

In accordance with the purpose(s) of the present disclosure, as embodied and broadly described herein, embodiments of the present disclosure, in one aspect, relate to pet beds. Referring now to FIG. 1A, shown is a perspective view of an example of a pet bed 100 in accordance with various embodiments of the present disclosure. The pet bed 100 includes a top portion 103 and a bottom portion 106, which are substantially similar in size and shape. The top portion 103 and bottom portion 106 are each comprised of fabric. The fabric can include, but is not limited to, polyester, cotton, stretch, polypropylene, polyester/cotton blend, nylon, rayon, tricot, Lycra, and a combination thereof.

Embodiments of the present disclosure include a pet bed 100 with a side wall 109, which creates a box-like construction when secured to the top portion 103 and bottom portion 106. The side wall 109 includes at least one side wall portion (i.e., gusset), depending upon the size and shape of the pet bed 100. In one embodiment, the side wall 109 includes one piece of rectangular-shaped fabric that is sewn together at the short ends with at least one seam. In another embodiment, the pet bed 100 is rectangular in shape and the side wall 109 includes four side walls portions (or gussets) that are sewn together at their short ends to make one continuous side wall 109.

Referring next to FIG. 1B, shown is a cut-away view of the pet bed 100 of FIG. 1A. Embodiments of the present disclosure include one or more interior walls 112 (e.g., strips of fabric) positioned and secured (e.g., sewn) between the top portion 103 and bottom portion 106 of the pet bed 100 to create baffles. The fabric of an interior wall can include, but is not limited to, polyester, cotton, stretch, polypropylene, polyester/cotton blend, nylon, rayon, tricot, Lycra, and a combination thereof. In addition, the fabric may be configured to allow air to flow through the fabric while preventing filler material to pass through the fabric.

In an embodiment, at least one interior wall 112 is secured between the top portion 103 and bottom portion 106 of the pet bed 100. In an embodiment, the interior wall(s) 112 can be rectangular in shape. In another embodiment, the interior walls run parallel to at least a portion of the side wall 109 as illustrated in FIG. 1B. The interior walls are secured (e.g., sewn) to the top portion 103 and bottom portion 106 of the pet bed 100 along their lengths. The one or more interior walls 112 create chambers 115 within the pet bed 100 (i.e., baffles), which prevent filling material inserted into the bed 100 from shifting and/or moving to any significant degree.

In an embodiment, the interior walls 112 are approximately the same height of the side wall 109. The interior wall(s) may be approximately the same length or width as the top and bottom portions 103 and 106. In another embodiment, the interior walls 112 are shorter in length or width (e.g., about 1½ to about 4 inches shorter) than the top and bottom portions 103 and 106. This allows filler material to be inserted into each chamber 115 of the pet bed 100.

In another embodiment, the interior walls 112 are taller in height than the side wall 109 (e.g., about 1 to about 2 inches taller). This allows filler material to loft to its fullest, thus creating a more comfortable and durable pet bed.

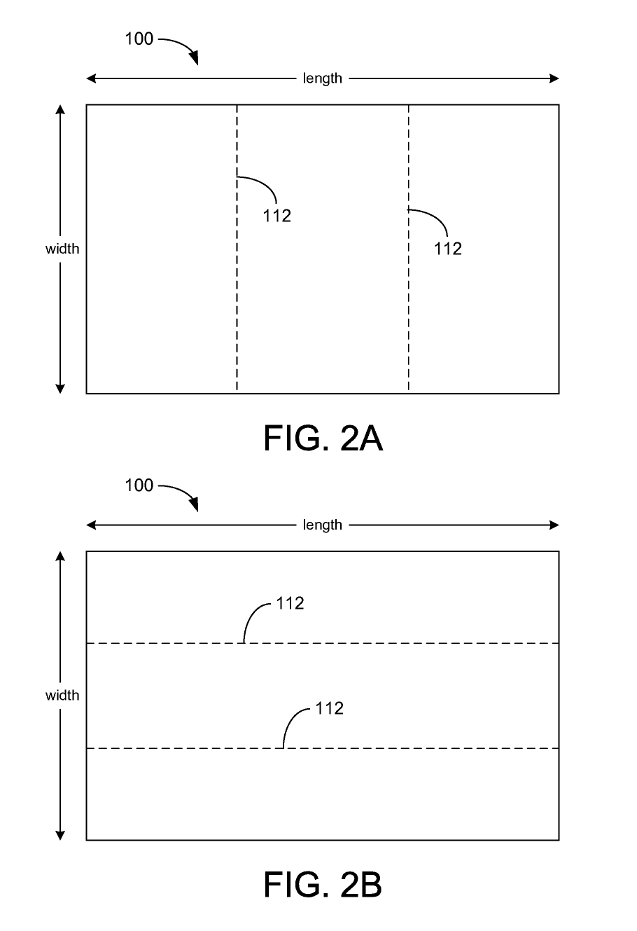

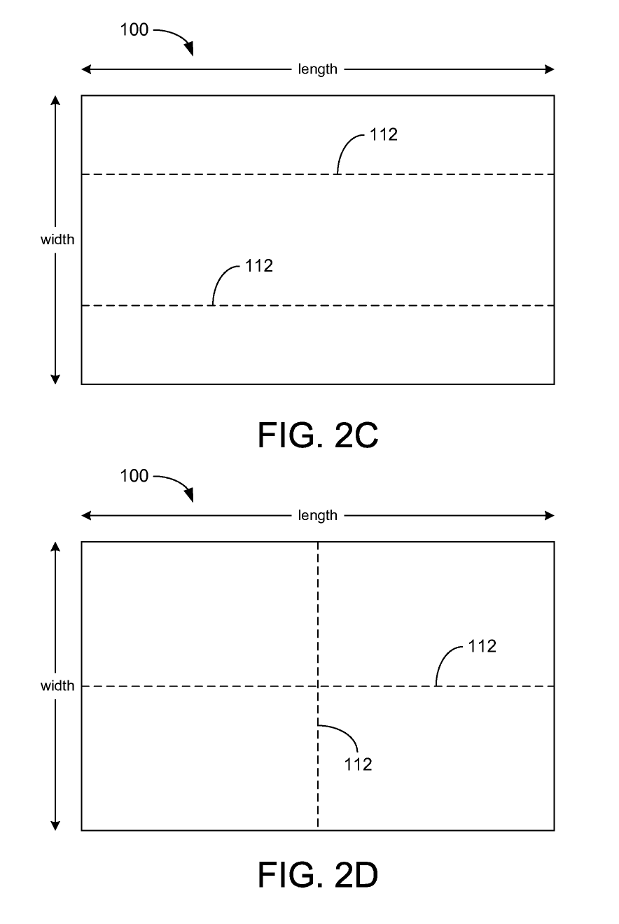

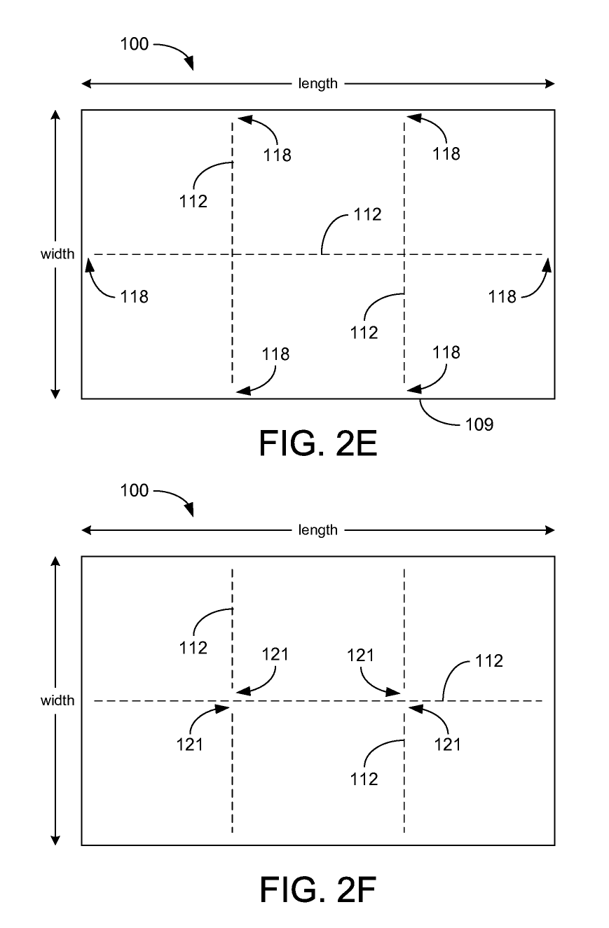

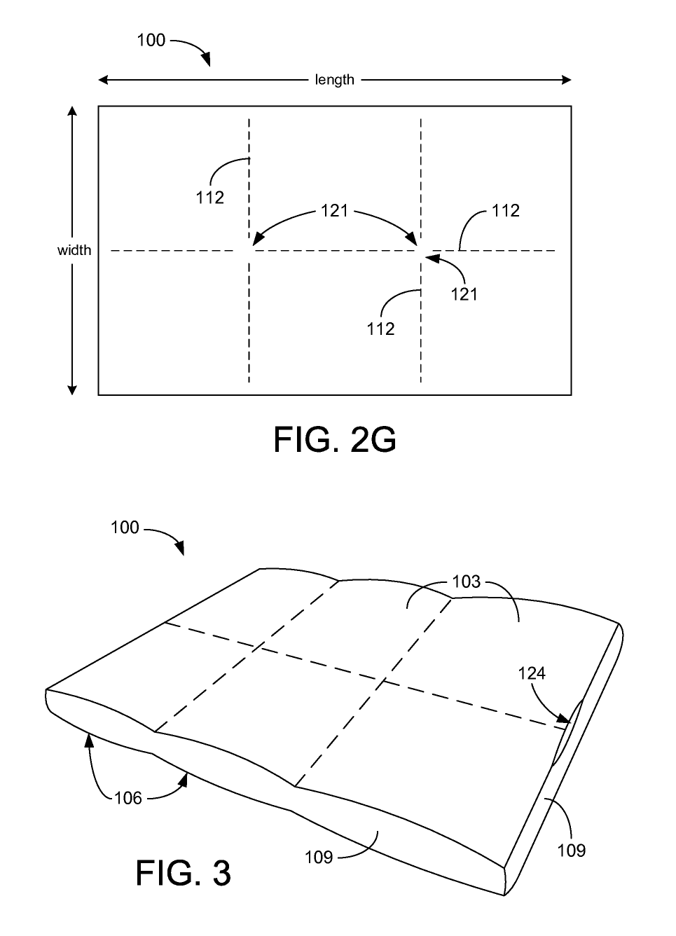

Referring now to FIGS. 2A-2G, shown are top views of examples of pet beds 100 in accordance with various embodiments of the present disclosure. FIGS. 2A-2G illustrate various interior wall 112 patterns that may be included within a pet bed 100. The number of interior walls/baffles 112 may be varied (e.g., 1 to 12). For example, an embodiment can include two interior walls 112 thus creating three chambers 115, as illustrated in FIGS. 2A-2C. In various embodiments, the interior walls 112 can be parallel to each other (e.g., FIGS. 2A-2C), perpendicular to each other (e.g., FIG. 2D), or a combination thereof (e.g., FIGS. 2E-2G). In addition, the interior walls 112 can be spaced evenly within the pet bed 100 (e.g., FIGS. 2A-2B) or can be spaced at unequal distances (e.g., FIG. 2C), thus creating chambers 115 within the pet bed 100 that are substantially the same size and shape or of different sizes and shapes. Other orientations may also be utilized. For example, the interior walls 112 may all radiate out from a central point in a circular pet bed.

FIG. 2A illustrates an embodiment of a pet bed 100 that includes three chambers 115 that are rectangular in shape and approximately the same size. FIG. 2A illustrates an embodiment of a pet bed 100 that includes three chambers 115 that are rectangular in shape and approximately the same size. FIG. 2C illustrates an embodiment of a pet bed 100 that includes three chambers 115 that are rectangular in shape, two of which are approximately the same size while the third chamber 115 is larger. FIG. 2D illustrates an embodiment of a pet bed 100 that includes four chambers 115 that are rectangular in shape and approximately the same size. FIGS. 2E-2G illustrate embodiments of pet beds 100 that include six chambers 115 that are rectangular in shape and approximately the same size.

In an embodiment of the present disclosure, the interior walls 112 are secured (e.g., sewn) to the top and bottom portions 103 and 106 of the pet bed 100, but are not secured (e.g., sewn) to the side wall 109. A gap 118 between side wall 109 and the interior wall 112 may also be included as illustrated in FIG. 2E. In some embodiments, the interior walls 112 may not be secured together. For example, one or more interior walls 112 may be discontinuous and gaps 121 may be provided between perpendicular interior walls 112 (see, e.g., FIGS. 2F-2G). In an embodiment, the interior walls 112 (or baffles) are substantially rectangular in shape and are approximately the same size. In other embodiments (e.g., in a circular pet bed), the interior walls and baffles may be of varied sizes/shapes.

In an embodiment of the present disclosure, the pet bed 100 includes one or more openings 124 into which the filler material is inserted into the chambers 115. The gaps between the side wall 109 and the interior wall 112 (e.g., gaps 118) and/or between interior walls 112 (e.g., gaps 121) allow adjacent chambers 115 to be filled from a common opening 124. For example, an opening 124 may be included along one side of the pet bed 100 between the side wall 109 and the top portion 103 as illustrated in FIG. 3 and/or between the side wall 109 and the bottom portion 106. In some embodiments, the opening is about 1 inch to about 12 inches long along the seam of the side wall 109. In another embodiment, the opening is about 6 inches to about 8 inches long. The opening can be secured in a closed position with, for example, a zipper or Velcro (i.e., so that it can be re-opened and/or closed again), or it can be sewn closed.

In an embodiment of the present disclosure, the pet bed 100 is packed with filler material, which can be a natural material, a man-made material, or a combination thereof. In one embodiment, the pet bed 100 is densely packed with the filler material. The filler material can include, but is not limited to polyester, polyester/shredded memory foam, shredded memory foam/gel, shredded memory foam, shredded fibers of unknown origin, feathers, down, polystyrene beads, shredded polyurethane foam, shredded latex foam, shredded memory foam/shredded polyurethane foam, cotton, or a combination thereof.

Embodiments of the present disclosure can include pet beds of various shapes and sizes including, but not limited to, rectangular (e.g., about 18″-48″ wide×about 22″-60″ long), square (e.g., up to 60 inch square), oval, and circular (e.g., up to 60 inch diameter).

In an embodiment of the present disclosure, the pet bed may be covered with fabric (e.g., an outer shell/cover) for comfort and aesthetic purposes. The cover may comprise a fabric including cotton, polyester, or a combination thereof. For example, a one fabric may be used to cover the top portion 103 and a different fabric may be used to cover the other portions of the pet bed 100. In an embodiment, the cover may also include ornamentation and/or design patterns.

Embodiments of the present disclosure include a pet bed comprising: a top portion; a bottom portion; a side wall, wherein the side wall is secured to both the top portion and the bottom portion creating a box-like construction; at least one interior wall, wherein the at least one interior wall is secured to both the top and bottom portions; at least two interior chambers formed by the top portion, the bottom portion, the side wall, and the at least one interior wall; and a filler material in all of the interior chambers.

In an embodiment, the top portion, bottom portion, side wall, and at least one interior wall are comprised of fabric selected from the group consisting of: polyester, cotton, stretch, polypropylene, polyester/cotton blend, nylon, rayon, tricot, Lycra, and a combination thereof.

In an embodiment of the present disclosure, the pet bed further comprises at least one opening into which the filler material is inserted.

In an embodiment of the present disclosure, both the top and bottom portions are rectangular in shape and approximately the same size. In another embodiment, two interior walls are secured to the top and bottom portions and the interior chambers formed therein are substantially the same size.

In an embodiment of the present disclosure, the pet bed includes interior walls that are parallel to each other. In another embodiment, the interior walls are perpendicular to each other. In another embodiment, the at least one interior wall is shorter in length than the side wall. In another embodiment, the at least one interior wall is greater in height than the side wall.

Embodiments of the present disclosure include pet beds where about 1 to 6 interior walls are secured to the top and bottom portions and the interior chambers formed therein are substantially the same size and shape. In an embodiment, the interior chambers formed therein are unequal in size.

Embodiments of the present disclosure include pet beds where the filler material is selected from the group consisting of: natural material, man-made material, and a combination thereof. In an embodiment, the filler material is selected from the group consisting of: polyester, polyester/shredded memory foam, shredded memory foam/gel, shredded memory foam, shredded fibers of unknown origin, feathers, down, polystyrene beads, shredded polyurethane foam, shredded latex foam, shredded memory foam/shredded polyurethane foam, cotton, and a combination thereof.

Embodiments of the present disclosure include pet beds where the at least one opening is about 1 to 12 inches long along the side wall. In an embodiment, the at least one opening is secured in a closed position with an apparatus selected from the group consisting of: a zipper, Velcro, and a combination thereof.

Embodiments of the present disclosure include pet beds there the pet bed is covered with an outer shell of fabric.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A pet bed comprising:
a top portion;
a bottom portion;
a side wall, wherein the side wall is secured to both the top portion and the bottom portion creating a box-like construction;
at least one interior wall, wherein the at least one interior wall is secured to both the top and bottom portions;
at least two interior chambers formed by the top portion, the bottom portion, the side wall, and the at least one interior wall; and
a filler material in all of the interior chambers.

2. The pet bed of claim 1, wherein the top portion, bottom portion, side wall, and at least one interior wall are comprised of fabric selected from the group consisting of: polyester, cotton, stretch, polypropylene, polyester/cotton blend, nylon, rayon, tricot, Lycra, and a combination thereof.

3. The pet bed of claim 1, further comprising at least one opening into which the filler material is inserted.

4. The pet bed of claim 1, wherein both the top and bottom portions are rectangular in shape and approximately the same size.

5. The pet bed of claim 1, wherein two interior walls are secured to the top and bottom portions and the interior chambers formed therein are substantially the same size.

6. The pet bed of claim 5, wherein the interior walls are parallel to each other.

7. The pet bed of claim 5, wherein the interior walls are perpendicular to each other.

8. The pet bed of claim 1, wherein the at least one interior wall is shorter in length than the side wall.

9. The pet bed of claim 1, wherein the at least one interior wall is greater in height than the side wall.

10. The pet bed of claim 1, wherein about 1 to 6 interior walls are secured to the top and bottom portions and the interior chambers formed therein are substantially the same size and shape.

11. The pet bed of claim 10, wherein the interior chambers formed therein are unequal in size.

12. The pet bed of claim 1, wherein the filler material is selected from the group consisting of: natural material, man-made material, and a combination thereof.

13. The pet bed of claim 12, wherein the filler material is selected from the group consisting of: polyester, polyester/shredded memory foam, shredded memory foam/gel, shredded memory foam, shredded fibers of unknown origin, feathers, down, polystyrene beads, shredded polyurethane foam, shredded latex foam, shredded memory foam/shredded polyurethane foam, cotton, and a combination thereof.

14. The pet bed of claim 3, wherein the at least one opening is about 1 to 12 inches long along the side wall.

15. The pet bed of claim 14, wherein the opening is secured in a closed position with an apparatus selected from the group consisting of: a zipper, Velcro, and a combination thereof.

16. The pet bed of claim 1, wherein the pet bed is covered with an outer shell of fabric.
